(19) United States
(12) Patent Application Publication
(10) Pub. No.: US 2026/0291722 A1
(43) Pub. Date: Sep. 24, 2026

(54) METHOD FOR ACQUIRING OPTICAL PUF-BASED ENCRYPTION CODE AND OPTICAL PUF-BASED ENCRYPTION CODE ACQUIRED USING THE SAME

(71) Applicant: THE INDUSTRY & ACADEMIC COOPERATION IN CHUNGNAM NATIONAL UNIVERSITY (IAC), Daejeon (KR)

(72) Inventors: Jun Hee NA, Sejong (KR); Ki Tae KIM, Daejeon (KR)

(73) Assignee: THE INDUSTRY & ACADEMIC COOPERATION IN CHUNGNAM NATIONAL UNIVERSITY (IAC), Daejeon (KR)

(21) Appl. No.: 19/474,215

(22) PCT Filed: Jul. 8, 2024
(86) PCT No.: PCT/KR2024/009647

§ 371 Date: Oct. 10, 2025

(30) Foreign Application Priority Data
Aug. 17, 2023 (KR) 10-2023-0107783

(51) Int. Cl. H04L 9/08

(52) U.S. Cl. CPC H04L 9/0866

(57) ABSTRACT

A method for acquiring an optical PUF-based encryption code includes: preparing an anisotropic refractive index material; acquiring a basic image by transmitting light through the anisotropic refractive index material and receiving the light having passed through the anisotropic refractive index material; generating a binary code image having a binary code corresponding to the interference pattern; generating an image cube by stacking a plurality of binary code images; and generating an optical PUF-based encryption code by selecting a plane containing a plurality of binary code images from the image cube and extracting a binary code from the plane.

### TECHNICAL FIELD

The present invention relates to a method for acquiring an optical PUF-based encryption code and an optical PUF-based encryption code acquired by the same and, more particularly, to a method for acquiring an encryption code based on an optical PUF different from a semiconductor-based PUF, and an optical PUF-based encryption code acquired by the same.

### BACKGROUND ART

Digital technology associated with the internet is advancing. Technologies such as the Internet of Things (IoT), big data, and cloud computing are creating complex digital networks that include smartphones, smart cards, and many other ubiquitous electronic devices and home appliances. As a result, a vast volume of digital information related to our lives is being created, stored, and shared on a daily basis.

However, such digital information is vulnerable to security breaches unless a high-level information security system is in place. One of the most important aspects of an information security system is authentication of individuals or entities seeking access to the information. This is typically done using an authentication protocol that relies on a unique and non-replicable digital signature, like a fingerprint.

In recent years, research on a physically unclonable function (hereinafter referred to as a “PUF”) has been actively underway as an alternative to typical information security systems.

PUFs originate from the unique characteristics of each semiconductor chip, which arise from different characteristics of the manufacturing process thereof, and are impossible to replicate since they generate an output that cannot be predicted by hardware mechanisms. This property has led to research on many types of PUFs, including Arbiter-PUFs, Ring Oscillator (RO)-PUFs, Loop PUFs, and VIA PUFs.

However, typical semiconductor-based PUFs require physical replacement or additional hardware components. Therefore, there is a need for PUF technology that can be implemented without these requirements and a method for acquiring an encryption code using such PUF technology.

### Related Literature

Korean Patent Laid-open Publication No. 2022-0000815 (published on Jan. 4, 2022)

### DISCLOSURE

### Technical Problem

It is an aspect of the present invention to provide a method for acquiring an encryption code based on an optical PUF different from a semiconductor-based PUF, and an optical PUF-based encryption code acquired by the method.

It should be understood that aspects of the present invention are not limited to those described above. The above and other aspects of the present invention will become apparent to those skilled in the art from the detailed description of the following embodiments in conjunction with the accompanying drawings.

### Technical Solution

In accordance with one aspect of the present invention, there is provided a method for acquiring an optical PUF-based encryption code, the method including: a material preparation step in which an anisotropic refractive index material is prepared; a basic image acquisition step in which a basic image having an interference pattern is acquired by transmitting light through the anisotropic refractive index material and receiving the light having passed through the anisotropic refractive index material; a binary code image generation step in which a binary code image having a binary code corresponding to the interference pattern is generated; an image cube generation step in which an image cube is generated by stacking a plurality of binary code images; and an encryption code generation step in which an optical PUF-based encryption code is generated by selecting a plane containing a plurality of binary code images from the image cube and extracting a binary code from the plane.

In one embodiment of the invention, the anisotropic refractive index material may be a liquid crystalline material not subjected to an alignment process.

In one embodiment of the invention, the anisotropic refractive index material may have wrinkles, and the interference pattern may be formed corresponding to the wrinkles.

In one embodiment of the invention, in the basic image acquisition step, the basic image may be acquired by receiving light having passed through crossed polarizing plates with the anisotropic refractive index material placed therebetween, and the basic image may have a random interference pattern depending on an angle of rotation of the crossed polarizing plates with respect to the anisotropic refractive index material.

In one embodiment of the invention, in the encryption code generation step, the plane may be a two-dimensional plane defined by three points randomly selected from the image cube.

In one embodiment of the invention, the plane may be selected from layered surfaces of the image cube, the layered surfaces being formed of a plurality of stacked binary code images.

In one embodiment of the invention, the plane may be selected from an interior of the image cube.

In one embodiment of the invention, in the encryption code generation step, the plane may include at least one surface of a three-dimensional figure defined by four or more points randomly selected from the image cube.

In one embodiment of the invention, the method may further include: a binary code image verification step in which randomness of the binary code image is verified based on the binary code.

In one embodiment of the invention, the method may further include: an image cube verification step in which randomness, uniqueness, and reliability of the image cube are verified.

In accordance with another aspect of the present invention, there is provided an optical PUF-based encryption code acquired by the method for acquiring an optical PUF-based encryption code set forth above.

### Advantageous Effects

The method according to invention can produce an optical PUF-based basic image capable of forming a specific pattern code, like a fingerprint, by utilizing randomness of the distribution of liquid crystal molecules and optical effects of a liquid crystal.

In addition, the method according to the invention enables implementation of PUFs requiring neither physical replacement nor additional hardware components, unlike typical semiconductor-based PUFs.

In addition, according to the invention, random free-form wrinkles in the optical PUF-based basic image are in a form that is physically impossible to clone. Accordingly, an optical PUF-based binary code image generated using the optical PUF-based basic image and an optical PUF-based image cube generated by stacking a plurality of binary code images may be used in anti-counterfeiting technology as a simple authentication method for applications requiring a higher security level.

In addition, the optical PUF-based encryption code acquired by the method according to the invention is a one-dimensional code and thus may also be utilized in a sequential authentication process.

It should be understood that advantageous effects of the present invention are not limited to those described above and include any advantageous effects conceivable from the features disclosed in the detailed description of the present invention or the appended claims.

### DESCRIPTION OF DRAWINGS

FIG. 1 is a flowchart of a method for acquiring an optical PUF-based encryption code according to one embodiment of the present invention.

FIG. 2 shows photographs of an anisotropic refractive index material, a basic image, and a binary code image in the method for acquiring an optical PUF-based encryption code according to the embodiment.

FIG. 3 is a diagram illustrating exemplary arrangement of crossed polarizing plates and the anisotropic refractive index material in the method for acquiring an optical PUF-based encryption code according to the embodiment.

FIG. 4 illustrates various basic images and binary code images depending on the angle of the crossed polarizing plates in the method for acquiring an optical PUF-based encryption code according to the embodiment.

FIG. 5 is a graph depicting the entropy of the binary code image along each axis thereof in the method for acquiring an optical PUF-based encryption code according to the embodiment.

FIG. 6 illustrates an image cube generated by the method for acquiring an optical PUF-based encryption code according to the embodiment.

FIG. 7 is a graph depicting the entropy of the image cube in the method for acquiring an optical PUF-based encryption code according to the embodiment.

FIG. 8 is a graph depicting the intra-HD and inter-HD of the image cube in the method for acquiring an optical PUF-based encryption code according to the embodiment.

FIG. 9 is an exemplary view of a two-dimensional plane selected from the image cube in the method for acquiring an optical PUF-based encryption code according to the embodiment.

FIG. 10 is an exemplary view illustrating a process of generating an optical PUF-based encryption code from the selected two-dimensional plane of FIG. 9.

FIG. 11 is an exemplary view of a three-dimensional figure selected from the image cube in the method for acquiring an optical PUF-based encryption code according to the embodiment.

FIG. 12 is an exemplary view illustrating a process of generating an optical PUF-based encryption code from each plane of the selected three-dimensional figure of FIG. 11.

### BEST MODE

A preferred embodiment of the present invention provides a method for acquiring an optical PUF-based encryption code, the method including: a material preparation step in which an anisotropic refractive index material is prepared; a basic image acquisition step in which a basic image having an interference pattern is acquired by transmitting light through the anisotropic refractive index material and receiving the light having passed through the anisotropic refractive index material; a binary code image generation step in which a binary code image having a binary code corresponding to the interference pattern is generated; an image cube generation step in which an image cube is generated by stacking a plurality of binary code images; and an encryption code generation step in which an optical PUF-based encryption code is generated by selecting a plane containing a plurality of binary code images from the image cube and extracting a binary code from the plane.

### Mode for Invention

Reference will now be made in detail to various embodiments, examples of which are illustrated in the accompanying drawings. It should be understood that the present invention may be embodied in different ways and is not limited to the following embodiments. In the drawings, portions irrelevant to the description will be omitted for clarity. Like components will be denoted by like reference numerals throughout the specification.

Throughout the specification, when an element or layer is referred to as being “on”, “connected to”, or “coupled to” another element or layer, it may be directly on, connected to, or coupled to the other element or layer or intervening elements or layers may be present. In addition, unless stated otherwise, the term “includes” should be interpreted as not excluding the presence of other components than those listed herein.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises”, “comprising”, “includes”, and/or “including” when used in this specification, specify the presence of stated features, integers, steps, operations, elements, components, and/or groups thereof, but do not preclude the presence or addition of one or more other features, integers, steps, operations, elements, components, and/or groups thereof.

Although a method described herein is presented in a series of numbered steps for clarity, it should be understood that this numbering doesn't dictate their sequence. Some of these steps may be skipped, performed in parallel, or performed in any suitable order. In general, though, the steps of the method proceed in the numerical order specified herein.

Hereinafter, exemplary embodiments of the present invention will be described with reference to the accompanying drawings.

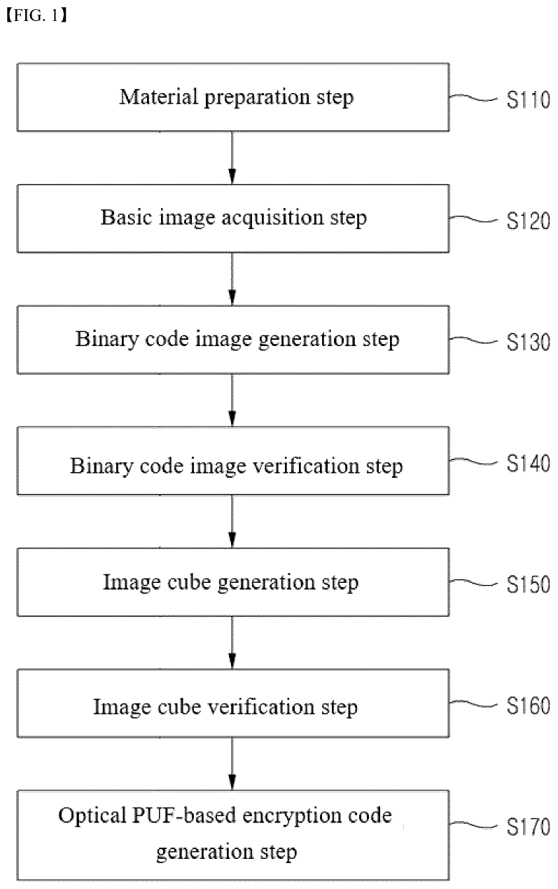

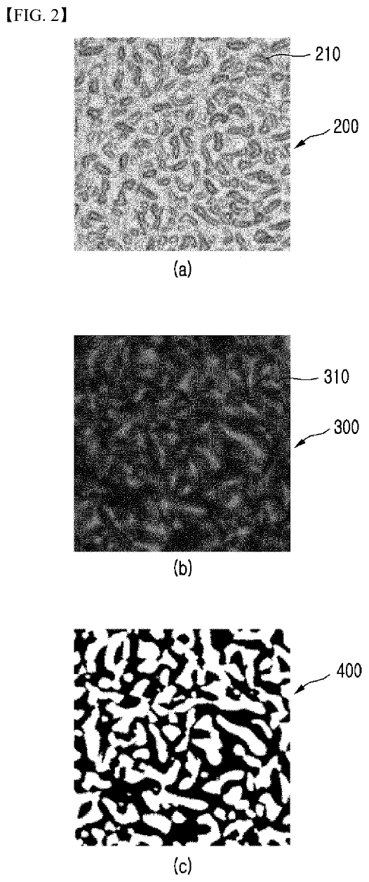

FIG. 1 is a flowchart of a method for acquiring an optical PUF-based encryption code according to one embodiment of the invention, and FIG. 2 shows photographs of an anisotropic refractive index material, a basic image, and a binary code image in the method for acquiring an optical PUF-based encryption code according to the embodiment.

Referring to FIG. 1 and FIG. 2, the method for acquiring an optical PUF-based encryption code may include a material preparation step S110, a basic image acquisition step S120, a binary code image generation step S130, an image cube generation step S150, and an encryption code generation step S170.

The material preparation step S110 may be a step in which an anisotropic refractive index material 200 is prepared.

The basic image acquisition step S120 may be a step in which a basic image 300 having an interference pattern 310 is acquired by transmitting light through the anisotropic refractive index material and receiving the light having passed through the anisotropic refractive index material.

The binary code image generation step S130 may be a step in which a binary code image 400 having a binary code corresponding to the interference pattern 310 is generated.

The image cube generation step S150 may be a step in which an image cube is generated by stacking a plurality of binary code images.

The encryption code generation step S170 may be a step in which an optical PUF-based encryption code is generated by selecting a plane containing a plurality of binary code images from the image cube and extracting a binary code from the selected plane.

The optical PUF-based encryption code generated by the method described above is in a form that is physically impossible to clone. Accordingly, the optical PUF-based encryption code may be used in anti-counterfeiting technology as a simple authentication method for applications requiring a higher security level.

Specifically, the material preparation step S110 may be a step in which an anisotropic refractive index material 200 is prepared.

Here, the anisotropic refractive index material 200 may be a liquid crystalline material not subjected to an alignment process. For example, the anisotropic refractive index material 200 may be a liquid crystal not subjected to an alignment process or a liquid crystalline polymer not subjected to an alignment process.

The anisotropic refractive index material 200 may have wrinkles 210 and may have optical anisotropy. The wrinkles 210 may be formed as the anisotropic refractive index material is cured.

The basic image acquisition step S120 may be a step in which a basic image 300 having an interference pattern 310 is acquired by transmitting light through the anisotropic refractive index material and receiving the light having passed through the anisotropic refractive index material.

In the basic image acquisition step S120, the basic image 300 may be acquired by receiving light having passed through crossed polarizing plates with the anisotropic refractive index material 200 placed therebetween.

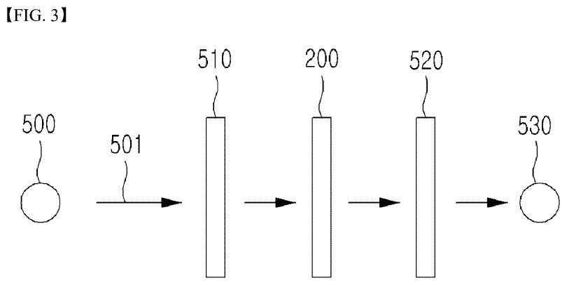

FIG. 3 is a diagram illustrating exemplary arrangement of the crossed polarizing plates and the anisotropic refractive index material in the method for acquiring an optical PUF-based encryption code according to the embodiment.

Referring to FIG. 3, the anisotropic refractive index material 200 may be disposed between a pair of crossed polarizing plates 510, 520. Light 501 emitted from a light source 500 may pass through the front polarizing plate 510, among the pair of crossed polarizing plates 510, 520, may then pass through the anisotropic refractive index material 200, may then pass through the rear polarizing plate 520, and may then be received by a light-receiving unit 530. Then, the basic image 300 may be acquired from the light received by the light-receiving unit 530.

The interference pattern 310 of the basic image 300 may be formed corresponding to the wrinkles 210 of the anisotropic refractive index material 200. Since the anisotropic refractive index material is a liquid crystal not subjected to an alignment process, the wrinkles 210 may be formed in a random manner, resulting in formation of a random interference pattern 310.

Since light transmittance of the anisotropic refractive index material depends on the orientation of liquid crystal molecules within the anisotropic refractive index material, the interference pattern 310 can be formed due to random variations in light brightness between the crossed polarizing plates 510, 520.

The basic image 300 may have a random interference pattern depending on the angle of rotation of the crossed polarizing plates 510, 520 with respect to the anisotropic refractive index material 200. In other words, each time the angle of the crossed polarizing plates is changed, light transmittance of the random wrinkles of the anisotropic refractive index material also changes, resulting in variations in the binary code acquired based on the interference pattern.

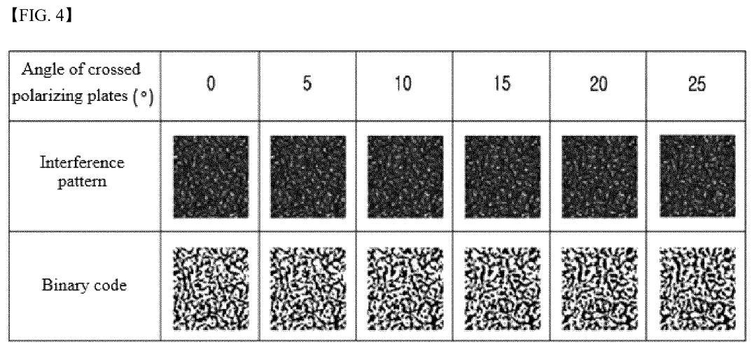

FIG. 4 illustrates various basic images and binary code images depending on the angle of the crossed polarizing plates in the method for acquiring an optical PUF-based encryption code according to the embodiment.

As shown in FIG. 4, it can be confirmed that changing the angle of rotation of the crossed polarizing plates 510, 520 in 5 degree increments results in distinct interference patterns 310 in respective acquired basic images. Although it has been described herein that the angle of rotation of the crossed polarizing plates 510, 520 is changed in 5 degree increments upon acquisition of the basic image, it should be understood that, even when the angle of rotation of the crossed polarizing plates 510, 520 is changed in 1 degree increments, respective acquired basic images can have distinct interference patterns 310.

Referring again to FIG. 1 to FIG. 4, the binary code image generation step S130 may be a step in which a binary code image 400 having a binary code corresponding to the interference pattern 310 is generated.

In the binary code image generation step S130, the binary code may be generated by algorithmically filtering the interference pattern 310 of the basic image 300. The binary code image 400 may be an image of the generated binary code.

The binary code may be set to “0” or “1”. The binary code may be generated in a natural form resembling the wrinkles of the liquid crystal, as shown in FIG. 2(c). That is, when the white portion is “0” and the black portion is “1” in the binary code image 400, the binary code can be generated in a more natural form resembling the wrinkles of the liquid crystal as the binary code image 400 is divided into smaller pixels. Furthermore, since the number of binary codes contained in the binary code image also increases for a given size of the binary code image, the degree of detail of the binary code can be increased.

Considering the processing speed for the generated binary code image 400, the binary code may be generated in a more simplified form, such as simple square pixels.

Since the binary code of the binary code image 400 is formed corresponding to the interference pattern 310 of the basic image 300, binary code images 400 generated corresponding to respective basic images having different interference patterns depending on the angle of rotation of the crossed polarizing plates, as shown in FIG. 4, can also have different binary codes.

The method for acquiring an optical PUF-based encryption code may further include a binary code image verification step S140.

The binary code image verification step S140 may be a step in which randomness of the binary code image is verified based on the binary code.

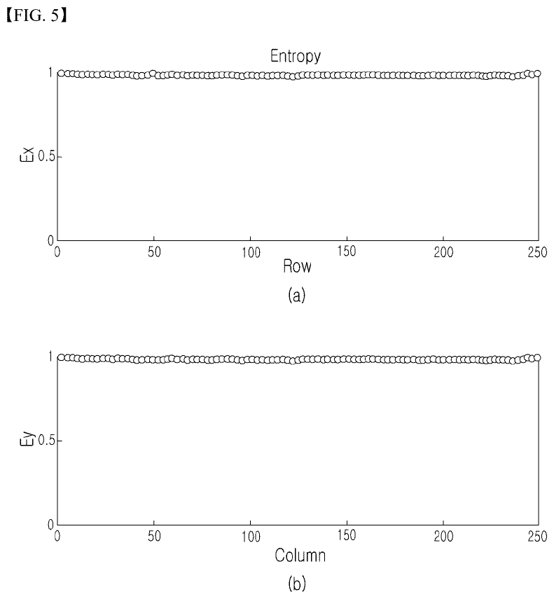

FIG. 5 is a graph depicting the entropy of the binary code image along each axis thereof in the method for acquiring an optical PUF-based encryption code according to the embodiment.

Using the Shannon entropy equation, entropy may be measured as a representation of the probability of the binary code being “0” or “1”. The entropy may serve as a measure of randomness.

A binary code image used for entropy measurement had a size of 250×250 pixels, corresponding to a total of 62,500 bits.

Then, using a standard equation, the entropy (Ex,y) was measured along the rows (X-axis) and columns (Y-axis) of binary codes. Here, “Ex,y” is defined as the probability of a corresponding binary code being set to “1” along each axis.

The average entropy Ex along the X-axis was measured to be equal to 0.9894±0.02 (see FIG. 5(a)), and the average entropy Ey along the Y-axis was measured to be equal to 0.9877±0.03 (see FIG. 5(b)). Since these values are close to 1, which represents perfect randomness, it can be confirmed that the binary code has perfect randomness.

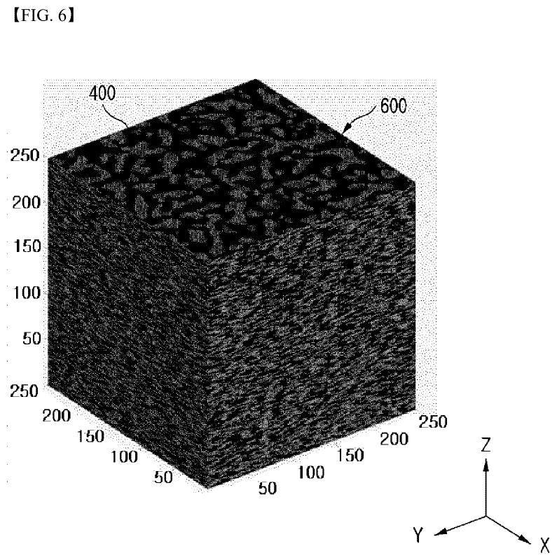

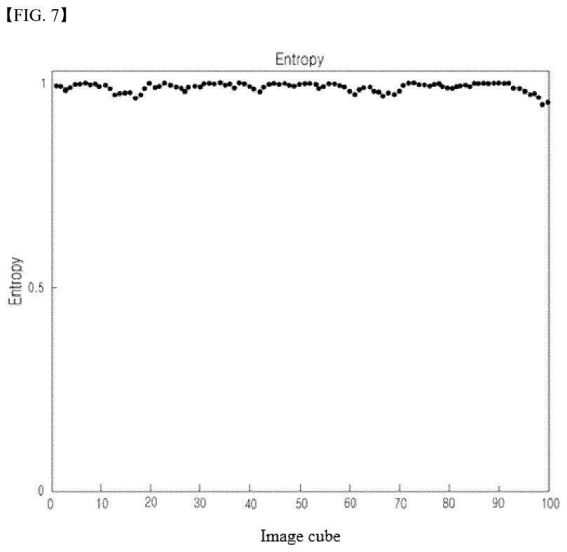

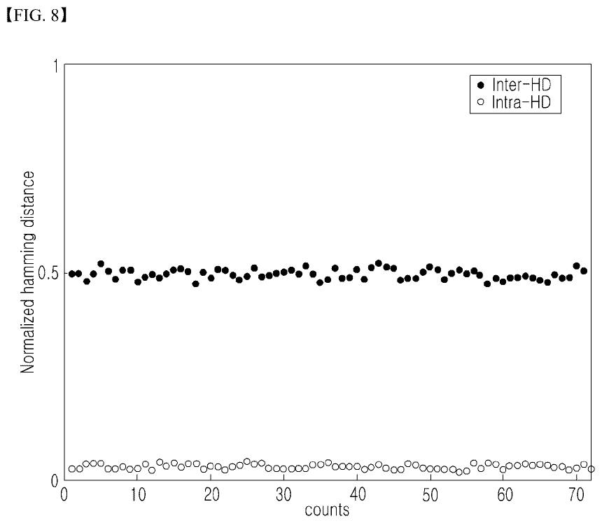

FIG. 6 is a view of an image cube generated by the method for acquiring an optical PUF-based encryption code according to the embodiment, FIG. 7 is a graph depicting the entropy of the image cube in the method for acquiring an optical PUF-based encryption code according to the embodiment, and FIG. 8 is a graph depicting the intra-HD and inter-HD of the image cube in the method for acquiring an optical PUF-based encryption code according to the embodiment.

Referring to FIG. 6 to FIG. 8, along with FIG. 1, the image cube generation step S150 may be a step in which an image cube is generated by stacking a plurality of binary code images.

In the image cube generation step S150, the plurality of binary code images 400 may be stacked in the Z-axis direction. The image cube 600 itself may be a random three-dimensional data set. Data in the X-axis and Y-axis planes of the image cube 600 may also be random.

The method for acquiring an optical PUF-based encryption code may further include an image cube verification step S160.

The image cube verification step S160 may be a step in which randomness and uniqueness of the image cube 600 are verified.

First, to verify whether the image cube 600 has randomness, the entropy of the image cube 600 may also be measured using the Shannon entropy equation.

An image cube 600 used for entropy measurement had a size of 250×250×250 pixels. The entropy of the image cube 600 was measured to be equal to 0.9912±0.02 based on the probability of each bit of the image cube 600 being set to “1”. Since this value is close to 1, which represents perfect randomness, it can be confirmed that the binary code has perfect randomness (see FIG. 7).

Furthermore, to verify whether the image cube 600 has uniqueness and reliability, Hamming distance (hereinafter referred to as “HD”) may be measured.

HD is a measure of similarity defined as the number of non-identical bits at a corresponding bit position. For example, the HD between “110010” and “101011” is 3.

There are two HD measurements: intra-Hamming distance (hereinafter referred to as “intra-HD”), which is calculated by measuring an image cube formed using an interference pattern of the same sample multiple times; and inter-Hamming distance (hereinafter referred to as “inter-HD”), which is calculated by measuring image cubes formed using interference patterns of different samples multiple times.

The value of intra-HD should ideally be equal to 0, as calculated by measuring an image cube formed using an interference pattern of the same sample multiple times.

To this end, intra-HD was measured multiple times on one image cube. Specifically, 70 intra-HD responses were captured using a single image cube. The resulting intra-HD value was 0.0512.

The value of inter-HD should ideally be equal to 0.5, as calculated by measuring image cubes formed using interference patterns of different samples multiple times.

To this end, inter-HD was measured multiple multiples on different image cubes. Specifically, 70 different image cubes were used to measure inter-HD. The resulting inter-HD value was 0.4989.

In summary, the measurement results showed that the binary code has both uniqueness and reliability, given that the intra-HD was 0.0512, which is close to the ideal value of 0, and the inter-HD was 0.4989, which is close to the ideal value of 0.5 (see FIG. 8).

As such, since it has been verified that the binary code image have randomness and the image cube have randomness, uniqueness, and reliability, an optical PUF-based encryption code described below, which is acquired using the image cube, may be used in anti-counterfeiting applications requiring a higher security level.

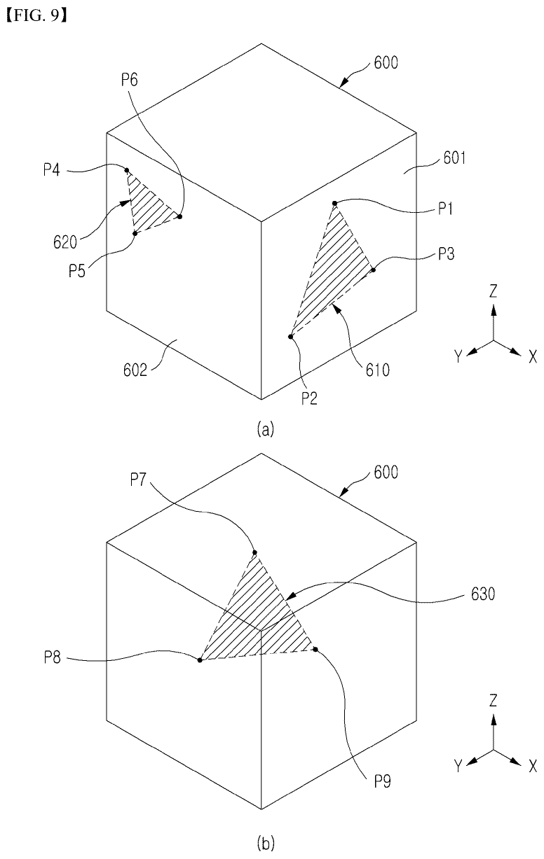

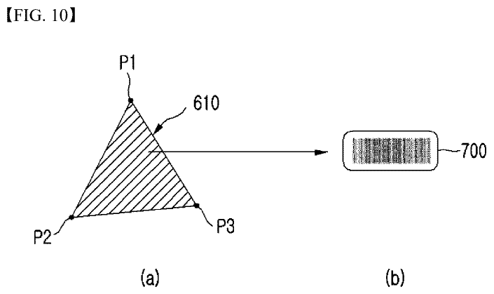

FIG. 9 is an exemplary view of a two-dimensional plane selected from the image cube in the method for acquiring a PUF-based encryption code according to the embodiment, and FIG. 10 is an exemplary view illustrating a process of generating an optical PUF-based encryption code from the selected two-dimensional plane of FIG. 9.

Referring to FIG. 1, FIG. 6, FIG. 9, and FIG. 10, the encryption code generation step S170 may be a step in which an optical PUF-based encryption code is generated by selecting a plane containing a plurality of binary code images 400 from the image cube 600 and extracting a binary code from the selected plane.

In the encryption code generation step S170, the plane may be a two-dimensional plane defined by three points randomly selected from the image cube 600.

The two-dimensional plane may be selected from layered surfaces of the image cube 600, which are formed by stacking a plurality of binary code images. Here, each of the layered surfaces may be a surface formed of a plurality of stacked binary code images. That is, the layered surfaces may be side surfaces of the image cube 600, respectively. Accordingly, although two layered surfaces 601, 602 are shown in FIG. 9(a), there are two more layered surfaces that are hidden from view.

When a two-dimensional plane 610 defined by three points P1, P2, P3 on the layered surface 601 on the right of FIG. 9(a) is selected, a binary code may be extracted from the selected two-dimensional plane 610 to generate an optical PUF-based encryption code 700 (see FIG. 10).

That is, the selected two-dimensional plane 610 may lie in the Y-Z plane and thus may form a new binary code based on binary codes in the Y-Z plane, among the binary codes of the plurality of stacked binary code images. The optical PUF-based encryption code 700 may be generated by extracting the new binary code that the selected two-dimensional plane 610 forms in the Y-Z plane.

The optical PUF-based encryption code 700 may be formed, for example, of binary codes sequentially extracted from the two-dimensional plane 610 in a row direction while moving from one column to the next.

Here, the extracted binary codes may be reconstructed into the optical PUF-based encryption code 700 using a preset algorithm. The optical PUF-based encryption code 700 may be a one-dimensional code. In other words, the optical PUF-based encryption code 700 may be a one-dimensional representation of the two-dimensional binary code contained in the two-dimensional plane 610.

The one-dimensional code exhibits a distribution that is not biased toward “0” or “1” and thus can provide enhanced security. Accordingly, the optical PUF-based encryption code 700 may be used in a wide range of security-related applications, such as security technology, anti-counterfeiting technology, and access control systems.

When a two-dimensional plane 620 defined by three points P4, P5, P6 on the layered surface 602 on the left of FIG. 9(a) is selected in the same manner as above, the selected two-dimensional plane 620 will have a new binary code in the X-Z plane, thereby allowing another optical PUF-based encryption code to be generated through extraction of the new binary code.

By varying the size, position, and shape of the plane defined by three points on each layered surface, a plane having a new binary code can be obtained. Through this, it is possible to obtain numerous planes each having a new binary code, thereby allowing acquisition of numerous optical PUF-based encryption codes having randomness, uniqueness, and reliability.

Alternatively, in the encryption code generation step S170, the two-dimensional plane defined by three points randomly selected from the image cube 600 may be selected from an interior of the image cube 600, as shown in FIG. 9(b).

Here, the two-dimensional plane may be selected not to lie in the same X-Y plane. To this end, the three points P7, P8, P9 may be selected not to lie in the same X-Y plane. The two-dimensional plane 630 defined by the three points P7, P8, P9 may be tilted or perpendicular with respect to a horizontal plane.

In the encryption code generation step S170, the plane may include at least one surface of a three-dimensional figure defined by four or more points randomly selected from the image cube 600.

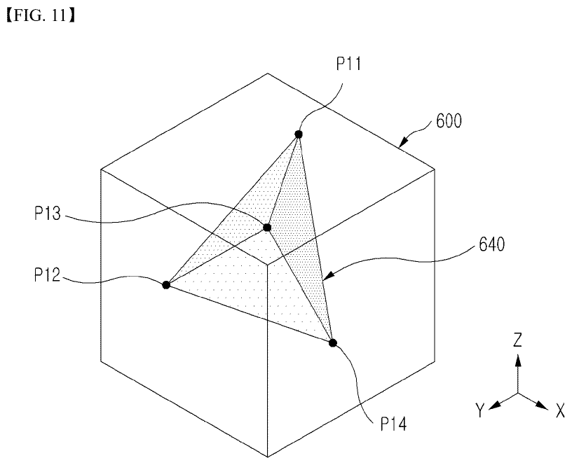

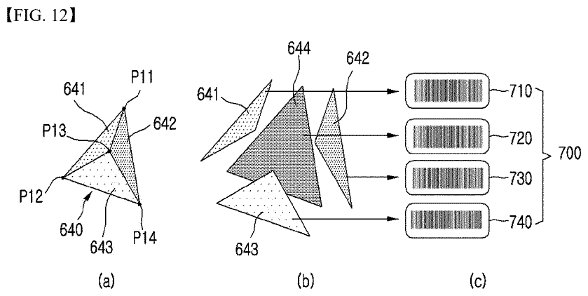

FIG. 11 is an exemplary view of a three-dimensional figure selected from the image cube in the method for acquiring an optical PUF-based encryption code according to the embodiment, and FIG. 12 is an exemplary view illustrating a process of generating an optical PUF-based encryption code from each surface of the selected three-dimensional figure of FIG. 11.

Referring to FIG. 11 and FIG. 12, when four points P11, P12, P13, P14 are randomly selected from the image cube 600, a three-dimensional FIG. 640 will be defined by the selected four points P11, P12, P13, P14. The three-dimensional FIG. 640 defined by the four points may have four surfaces 641, 642, 643, 644. The plane used in the encryption code generation step S170 may be one or more of the four surfaces 641, 642, 643, 644. The optical PUF-based encryption code 700 may be extracted from each of the selected surfaces.

Thus, since a plurality of optical PUF-based encryption codes 710, 720, 730, 740 may be acquired from the different surfaces 641, 642, 643, 644, respectively, each of the optical PUF-based encryption codes 710, 720, 730, 740 may be unique.

In this way, it is possible to generate an optical PUF-based encryption code capable of being utilized as a three-dimensional password, offering a more advanced alternative to a simple two-dimensional password.

As described above, the method according to the invention can produce an optical PUF-based basic image capable of forming a specific pattern code, like a fingerprint, by utilizing randomness of the distribution of liquid crystal molecules and optical effects of a liquid crystal.

In addition, the method according to the invention enables implementation of PUFs requiring neither physical replacement nor additional hardware components, unlike typical semiconductor-based PUFs.

In addition, according to the invention, the random free-form wrinkles in the optical PUF-based basic image are in a form that is physically impossible to clone. Accordingly, the optical PUF-based binary code image generated using the optical PUF-based basic image, and the optical PUF-based image cube generated by stacking a plurality of binary code images may be used in anti-counterfeiting technology as a simple authentication method for applications requiring a higher security level.

In addition, the optical PUF-based encryption code acquired by the method according to the invention is a one-dimensional code and thus may also be utilized in a sequential authentication process.

Although some embodiments have been described herein, it should be understood by those skilled in the art that various modifications, changes, alterations, and equivalent embodiments can be made without departing from the spirit and scope of the invention. Therefore, the embodiments described above are to be considered in all respects as illustrative and not restrictive. For example, components described as implemented separately may also be implemented in combined form, or vice versa.

The scope of the invention is indicated by the following claims and all changes or modifications derived from the meaning and scope of the claims and equivalents thereto should be construed as being within the scope of the invention.

### List of Reference Numerals

200: Material with an anisotropic refractive index
210: Wrinkle
300: Basic image
310: Interference pattern
400: Binary code image
600: Image cube
610, 620, 630: Two-dimensional plane
640: Three-dimensional FIG.
700: Optical PUF-based encryption code

1. A method for acquiring an optical PUF-based encryption code, comprising:
a material preparation step in which an anisotropic refractive index material is prepared;
a basic image acquisition step in which a basic image having an interference pattern is acquired by transmitting light through the anisotropic refractive index material and receiving the light having passed through the anisotropic refractive index material;
a binary code image generation step in which a binary code image having a binary code corresponding to the interference pattern is generated;
an image cube generation step in which an image cube is generated by stacking a plurality of binary code images; and
an encryption code generation step in which an optical PUF-based encryption code is generated by selecting a plane containing a plurality of binary code images from the image cube and extracting a binary code from the plane.

2. The method according to claim 1, wherein the anisotropic refractive index material is a liquid crystalline material not subjected to an alignment process.

3. The method according to claim 1, wherein
the anisotropic refractive index material has wrinkles, and
the interference pattern is formed corresponding to the wrinkles.

4. The method according to claim 1, wherein,
in the basic image acquisition step, the basic image is acquired by receiving light having passed through crossed polarizing plates with the anisotropic refractive index material placed therebetween, and
the basic image has a random interference pattern depending on an angle of rotation of the crossed polarizing plates with respect to the anisotropic refractive index material.

5. The method according to claim 1, wherein, in the encryption code generation step, the plane is a two-dimensional plane defined by three points randomly selected from the image cube.

6. The method according to claim 5, wherein the plane is selected from layered surfaces of the image cube, the layered surfaces being formed of a plurality of stacked binary code images.

7. The method according to claim 5, wherein the plane is selected from an interior of the image cube.

8. The method according to claim 1, wherein, in the encryption code generation step, the plane comprises at least one surface of a three-dimensional figure defined by four or more points randomly selected from the image cube.

9. The method according to claim 1, further comprising:
a binary code image verification step in which randomness of the binary code image is verified based on the binary code.

10. The method according to claim 1, further comprising:
an image cube verification step in which randomness, uniqueness, and reliability of the image are verified.

11. An optical PUF-based encryption code acquired by the method for acquiring an optical PUF-based encryption code according to claim 1.
